(19) United States
(12) Patent Application Publication
(10) Pub. No.: US 2008/0299939 A1
(43) Pub. Date: Dec. 4, 2008

(54) EMERGENCY BEACON FOR CELL PHONE OR THE LIKE

(76) Inventors: Vincent Apodaca, Albuquerque, NM (US); Chris McConnell, Gilbert, AZ (US); Dick Maguire, Albuquerque, NM (US)

Correspondence Address: COOL PATENT, P.C.;c/o INTELLEVATE, P.O. BOX 52050, MINNEAPOLIS, MN, 55402, US

(21) Appl. No.: 11/755,533

(22) Filed: May 30, 2007

(51) Int. Cl. G08B 3/00

(52) U.S. Cl. 455/404.2

(57) ABSTRACT

Briefly, in accordance with one or more embodiments, in an emergency situation, if a cell phone or a similar device is unable to communicate with a cell tower or other base station, the cell phone or similar device may enter into a beacon mode and transmit a beacon signal. The beacon signal may be utilized to help locate the user of the cell phone or similar device.

### BACKGROUND

Current cell phones may provide little or no use for emergency purposes in remote areas far from any cell phone towers. For example, a hiker lost in a rural area or a driver stranded in a remote location may need to signal for help as well as provide their location to emergency responders. Wireless cell phone service coverage in rural areas may be non-existent and as a result users in need of emergency aid may be unable to summon aid. As a result, emergency responders may have difficulty in determining the location of such persons requiring aid.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a cellular telephone or the like in accordance with one or more embodiments;

FIG. 2 is a diagram of a cellular telephone transmitting a cellular telephone signal and a beacon signal in accordance with one or more embodiments; and

FIG. 3 is a flow chart of a method for transmitting via a beacon in an emergency or similar situation in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

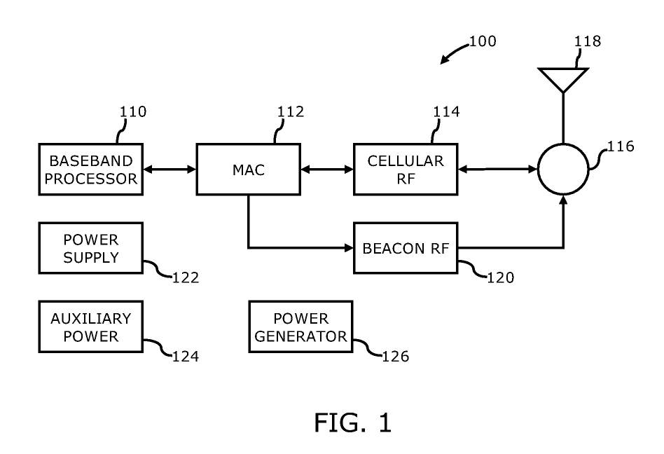

Referring now to FIG. 1, a block diagram of a cellular telephone or the like in accordance with one or more embodiments will be discussed. As shown in FIG. 1, cellular telephone 100, also referred to as a cell phone, may comprise a baseband processor 110, media access controller 112, and/or radio-frequency (RF) transceiver 114 for operation of cell phone on one or more cellular telephone bands. Cellular RF signals may be sent and received by RF transceiver 114 via antenna 118 by from a base station transceiver located in a cell in which cell phone 100 may be operating. Cell phone 100 may further comprise a power supply 122 such as a battery and/or receive power from an external circuit such as a direct-current (dc) or alternating-current (ac) power adapter. In one or more embodiments, cell phone 100 may alternatively comprise a personal digital assistant (PDA), smartphone, personal computer (PC), wireless local area network (WLAN) adapter card, wireless wide area network (WWAN) adapter card, global positioning system (GPS) type device, and so on. However, these are merely example embodiments of cell phone 100, and the scope of the claimed subject matter is not limited in these respects.

In one or more embodiments, cell phone 100 may include a beacon radio-frequency (RF) transmitter 120, for example coupled to media access controller 112 and also coupled to antenna 118 via combiner 116. In one or more embodiments, beacon RF transceiver 120 comprise a separate integrated circuit or chip than cellular RF transceiver 114, and in one or more alternative embodiments beacon RF transceiver 120 and cellular RF transceiver 114 may comprise a single integrated circuit or chip. Furthermore, beacon RF transceiver 120 and cellular RF transceiver 114 may at least partially share some common circuitry, for example via tunable RF circuits. Beacon RF transceiver 120 may operate at the same or nearly the same frequency as cellular RF transceiver 114, and/or may operate one or more different frequencies than cellular RF transceiver. However, these are merely example embodiments of beacon RF transceiver 120 and/or cellular RF transceiver 114, and the scope of the claimed subject matter is not limited in these respects.

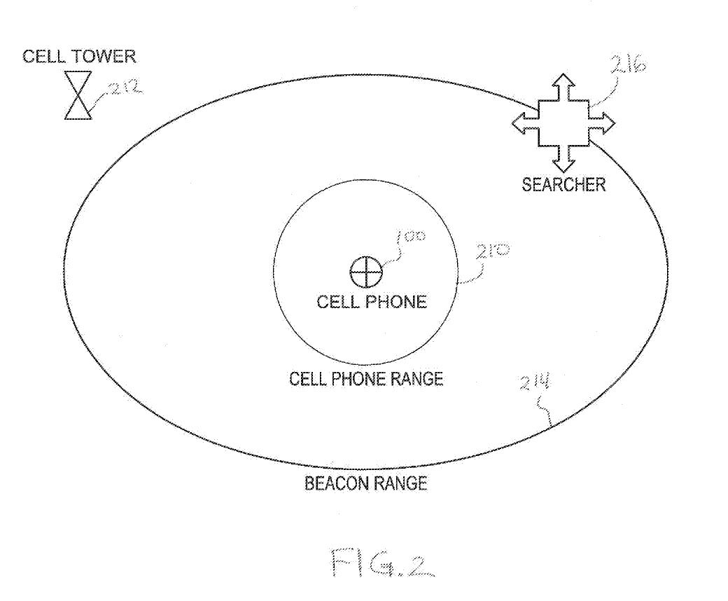

In one or more embodiments, a user of cell phone 100 is capable of signaling for emergency aid or the like, and/or indicating the location of the user via the transmission of an emergency beacon signal at a predefined frequency by beacon RF transceiver 120. Such an emergency signal or the like allows emergency response personal to determine the location of the user of cell phone 100 by tracking the source of the beacon signal. In one or more embodiments, cell phone 100 may include an auxiliary power source 124 disposed externally and/or internally to cell phone 100, and furthermore may also include a power generator 126 disposed externally and/or internally to cell phone 100 for providing additional operating power and/or charging power to power supply 122 and/or auxiliary power supply 124. Such an external power generator 126 is further discussed with respect to FIG. 2, below.

Referring now to FIG. 2, a diagram of a cellular telephone transmitting a cellular telephone signal and a beacon signal in accordance with one or more embodiments will be discussed. As shown in FIG. 2, a user of cell phone 100 needing emergency help may be located too far from a nearby cell tower 212 to communicate via a cellular telephone network such that cell tower 212 may be located outside the operational range 210 of cell phone 100 and/or there may be an obstruction between cell tower 212 and cell phone 100, to great an amount of multipath and/or fading effects, and so on. Therefore, normal operation of cell phone 100 may not be available to call for help. In one or more embodiments, the user of cell phone 100 is capable of switching cell phone 100 to a beacon mode in which case a periodic emergency signal may be broadcast via beacon RF transceiver 120. In one or more embodiments, beacon range 214 of the beacon signal may be smaller or larger than cell phone range 210, for example depending on the nature of the emergency beacon signal, power strength of beacon RF transceiver 120, power of power supply 122, auxiliary power supply 12, and/or auxiliary power, and so on. At some point in time, a searcher 216 such as a search team may enter within beacon range 214, detect the beacon signal broadcast by cell phone 100, and then track the beacon signal to the user of cell phone 100 needing help.

Thus, in one or more embodiments the user of cell phone 100 is capable of transmitting a beacon signal by switching cell phone 100 to beacon mode. In such a beacon mode, cell phone 100 may broadcast a signal at a standard frequency that is capable of being detected with a receiver in a manner substantially similar to the black boxes currently utilized in the aviation industry, for example location transponders and so on. Cell phone 100 may transmit a signal pulse at regular intervals, such as once per second or less frequently such as once per minute or once per every five minutes, for example in order to conserve power. Emergency responders searching for the user of cell phone 100, for example who may be a lost hiker, may listen for signals at the predefined frequency of the beacon signal. In one or more embodiments, searcher 216 may comprise an unmanned aerial vehicles (UAV) employed to listen for beacon signals over a larger search area than a rescue team can cover by foot. In any event, once a signal is found searcher 216 may analyze signal strength of the beacon signal while traversing a search area in order to zero in on the signal source.

In one or more embodiments, cell phone 100 may utilize a normal battery as power supply 122, and may optionally utilize a secondary battery as auxiliary power supply 124 that may be utilized for the beacon mode of cell phone 100. Such a secondary battery may utilize a trickle charge arrangement and/or a solar panel such a solar panel substantially similar to the solar panel utilized in calculators to provide sufficient lower power for the beacon signal transmitted by beacon RF transceiver 120. Beacon mode may also work when connected to an external auxiliary power source 124 such as a car battery, a larger solar panel, and/or a power generator 126 such as a kinetic power generator. In one or more embodiments, a solar panel or the like could be an item stored in a vehicle or backpack and retained for emergency purposes. In one or more embodiments a power generator 126 such as a kinetic power generator may comprise a foot pedal or hand crank that contains mechanical and/or electrical devices to harvest energy, for example similar to a wind up and/or kinetically charge light emitting device (LED) flashlights to provide power for operating cell phone 100 in a beacon mode. In one or more embodiments, due to the intermittent and/or pulse nature of the beacon signal, the power usage of cell phone 100 while in a beacon mode may be less than that of normal operation of cell phone 100, thereby allowing power supply 122 and/or auxiliary power supply to be utilized for longer periods of time. Furthermore, in one or more embodiments, the beacon signal transmitted by cell phone 100 may be a unique signal from any normal cell phone signals, and in one or more alternative embodiments, the beacon signal may be at least part of or a subset of a normal cell signal and/or be the same signal as the cell phone signal, at least in part, although the scope of the claimed subject matter is not limited in these respects.

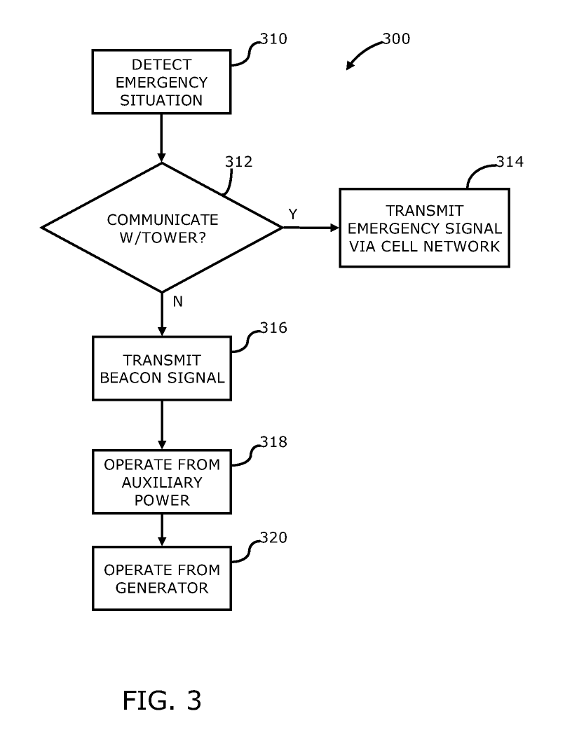

Referring now to FIG. 3, a flow chart of a method for transmitting via a beacon in an emergency or similar situation in accordance with one or more embodiments will be discussed. Method 300 may comprise the order and/or number of blocks shown in FIG. 3, and also may include more or fewer blocks which may be arranged in one or more different orders, and the scope of the claimed subject matter is not limited in these respects. An emergency situation may be detected at block 310, for example were a user of cell phone 100 activates an emergency mode and/or actuates an emergency button of cell phone 100. A determination may be made at decision block 312 whether cell phone 100 is capable of communicating with cell tower 212. In the event that cell phone 100 is capable of communicating with cell tower 212, cell phone 100 may transmit an emergency signal at block 314 via the cellular telephone network, for example an alarm signal or a 911 call to an emergency call center. In the event cell phone 100 is not capable of communicating with cell tower 212, for example if the signal is too low and/or contains too many errors, cell phone 100 may activate a beacon mode and transmit a beacon signal at block 316. Optionally, cell phone 100 may operate at block 318 in a beacon mode from auxiliary power supply 124 such as an auxiliary battery and/or dc or ac power source. Optionally, cell phone 100 may also operate at block 320 from a power generator 126 such as a hand crank, foot pedal, or other kinetic type generator. Method 300 may be implemented by baseband processor 110 and/or media access controller 112, for example via code, software, and or instructions, for example, although the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to emergency beacon for cell phone or the like and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus, comprising:
a media access controller;
a first radio-frequency transceiver coupled to the media access controller and capable of communicating via a wireless network; and
a second radio-frequency transceiver coupled to the media access controller and capable of transmitting a beacon signal;
wherein the media access controller is capable of causing the second radio-frequency transceiver to transmit the beacon signal in response to an emergency situation.

2. An apparatus as claimed in claim 1, wherein the second radio-frequency transceiver does not transmit the beacon in the absence of an emergency situation.

3. An apparatus as claimed in claim 1, the first radio-frequency transceiver comprising a local area network transceiver, or a wide area network transceiver, or combinations thereof.

4. An apparatus as claimed in claim 1, the first radio-frequency transceiver comprising a cellular telephone transceiver.

5. An apparatus as claimed in claim 1, the media access controller being capable of causing the second radio-frequency transceiver to transmit the beacon signal if the first radio-frequency transceiver is unable to successfully communicate with a base station.

6. An apparatus as claimed in claim 1, the media access controller being capable of causing the second radio-frequency transceiver to transmit the beacon signal if the first radio-frequency transceiver is unable to successfully communicate with a cell tower.

7. An apparatus as claimed in claim 1, further comprising an auxiliary power source, or a power generator, or combinations thereof, capable of providing operational power to the second radio-frequency transceiver.

8. An apparatus as claimed in claim 1, said first radio-frequency transceiver comprising the same transceiver, at least partially the same transceiver, or being disposed on the same integrated circuit, or combinations thereof.

9. A method, comprising:
detecting an emergency situation;
in response to said detecting, determining if communication with a base station is available; and
if communication with a base station is unavailable, transmitting a beacon signal indicative of a location of a user.

10. A method as claimed in claim 9, said detecting comprising a user activating a beacon mode, or actuating an emergency button, or combinations thereof.

11. A method as claimed in claim 9, said detecting comprising determining that communication with a base station is unavailable.

12. A method as claimed in claim 9, comprising operating from auxiliary power, or from a generator, or combinations thereof.

13. A method as claimed in claim 9, said transmitting a beacon signal comprising transmitting the beacon signal intermittently, or at a lower power, or combinations thereof.

14. A method as claimed in claim 9, in response to said determining if communication with a base station is available comprising determining if the cell tower is outside a cell phone range.

15. A method as claimed in claim 9, wherein the beacon signal is a standardized signal.
